(19) United States
(12) Patent Application Publication
(10) Pub. No.: US 2005/0234780 A1
(43) Pub. Date: Oct. 20, 2005

(54) Method of providing one stop shopping for residential homes using a centralized internet-based web system

(76) Inventor: Jamesena Binder, Upper Marlboro, MD (US)

Correspondence Address: IRVING M. WEINER;WEINER & BURT, P.C., 635 N. US-23, P.O. BOX 186, HARRISVILLE, MI, 48740, US

(21) Appl. No.: 10/824,280

(22) Filed: Apr. 14, 2004

(51) Int. Cl. G06F 17/60

(52) U.S. Cl. 705/26

(57) ABSTRACT

A method of providing one stop shopping for the homeowner via a centralized Internet-based web system that provides discounted products and services for the residential homeowner.

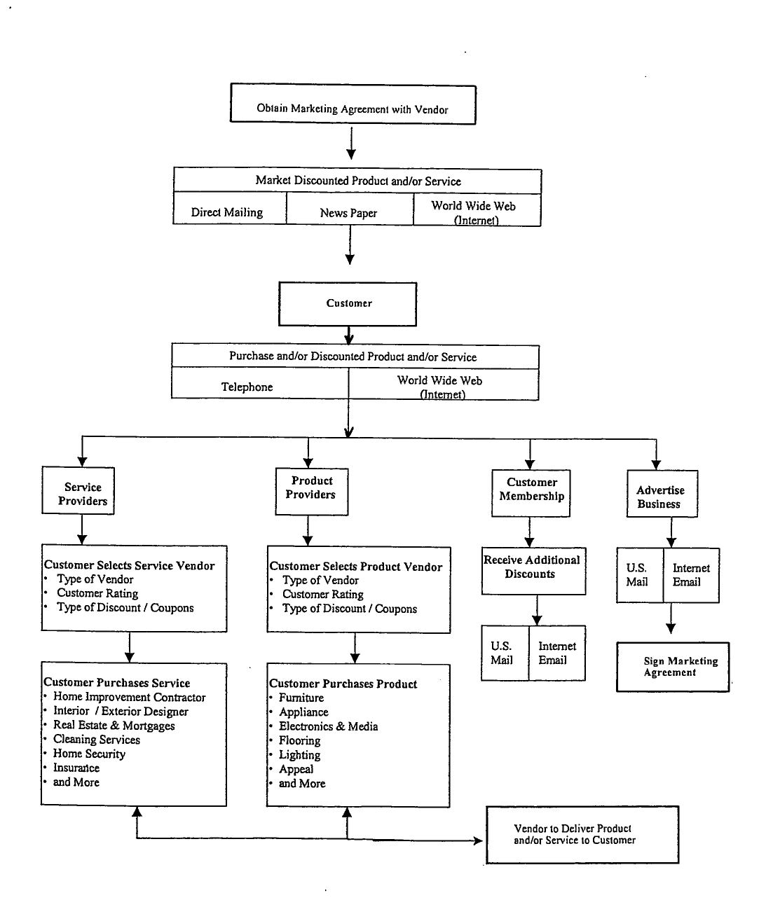

The present invention relates generally to a one stop shopping method for the home.

More particularly, the present invention relates to a one stop shopping method for the home which provides a centralized Internet-based web system that provides products and services for residential homes.

### BACKGROUND OF THE INVENTION

At the present time, there exists no single source of resources for residential properties whereby using a centralized Internet-based web system, the homeowner can order discounted products and services for residential homes.

The prior, but necessarily relevant, art is exemplified by the following United States patents.

Kenney U.S. Pat. No. 6,026,376, entitled “INTERACTIVE ELECTRONIC SHOPPING SYSTEM AND METHOD”, discloses an interactive electronic shopping system and method which creates a virtual shopping facility from an actual shopping facility, such as a grocery store, restaurant, or office. A shopper at a computer or other suitable display device can move through the virtual shopping facility and see replicas of what would be seen in moving through the actual shopping facility. Various lists of items selected for purchase can be made, and predetermined lists and information can be displayed. Changes in the actual shopping facility, such as a change in a display of goods, can be accommodated by replacing prior data with new data so that the virtual shopping environment is kept current with the actual shopping facility.

Wren U.S. Pat. No. 6,055,514, entitled “SYSTEM FOR MARKETING FOODS AND SERVICES UTILIZING COMPUTERIZED CENTRAL AND REMOTE FACILITIES”, discloses a system for shopping for goods and services including central communications facilities and remote communication facilities connected by communication links and permitting data communications between them. Central communication facilities offer goods and services in competition with each other. Each central communications facility stores, in addition to data, graphics in the form of video, and audio in the form of computerized voice and music. Computer input devices at each remote communications facility permit customers to access the data, graphics and audio. Computers at each remote communications facility also enable that facility to receive and download the data, graphics and audio. Each remote communications facility is adapted to enable a customer, after viewing the data, graphics and audio, to electronically negotiate a price for the purchase of the goods and services. Each central communications facility can generate and transmit to the remote facility transaction specific paperwork relative to the price so negotiated.

Yagasaki U.S. Pat. No. 6,125,353, entitled “MALL SERVER WITH PRODUCT SEARCH CAPABILITY”, discloses a mall server with a product search function, in which each product category has a particular effective period during which it is presented to customers as a selectable search key. In a virtual shopping mall system, customers can conduct a search for a set of products by designating a particular product category as a search key. As part of a mall server, a category master table stores a plurality of product categories accompanied by information on their respective category definitions. Based on the category master table, a product search screen generation unit produces product search screen data containing a set of categories whose effective periods include the present date. Receiving the product search screen data from the mall server, the customer terminal displays a product search screen including a category selection menu to provide the customer with a list of selectable categories. The customer issues a search request after selecting one category from the list. A product searching unit searches the product master table for the products that fall under the selected category. The customer terminal displays a product list screen upon receipt of the product list screen data from the mall server.

It is a desideratum of the present invention to avoid the animadversions of the presently available systems and methods, and to provide a novel and unique method of marketing and ordering discounted products and services for the homeowner.

### SUMMARY OF THE INVENTION

The present invention provides a method of providing one stop shopping for the home using a centralized Internet-based web system which enables a homeowner/customer to order products and/or services for residential homes, comprising the steps of: obtaining a marketing agreement between a company and a vendor of discounted products and/or services; marketing said discounted products and/or services by the Internet, direct mailing, and/or newspaper to homeowners/customers; purchasing one or more of said discounted products and/or services via the Internet and/or telephone; said discounted products includes, but is not limited to, furniture, appliances, electronics and media, flooring, lighting, etc.; and said discounted services includes, but is not limited to, home improvement contractors, interior/exterior designers, real estate and mortgages, cleaning services, home security, insurance, etc.

It is a primary object of the present invention to provide a novel and unique method as mentioned hereinabove, which offers the homeowner one stop shopping for the home.

Another object of the present invention is to provide such a novel and unique method as described hereinabove, using a centralized Internet-based web system which provides discounted products and services for residential homes.

Yet a further object of the present invention is to provide such a novel and unique method as described hereinabove, which offers quality discounted services and products via the Internet.

Another object of the present invention is to provide a novel and unique method as described hereinabove, wherein the Internet site serves as a single source of resources for residential properties.

Yet a further object of the present invention is to provide a novel and unique method as described hereinabove, wherein the discounted services will include interior/exterior home design, landscaping, home improvement, remodeling, plumbing, carpet cleaning, and discounted products such as appliances, furniture and home essentials.

Further objects, advantages, and features of the present invention will become apparent to those persons skilled in this particular area of technology and to other persons after having read the detailed description as set forth hereinbelow in conjunction with the accompanying drawing.

### BRIEF DESCRIPTION OF THE DRAWINGS

The drawing illustrates a flow chart in accordance with the method of the present invention.

### DETAILED DESCRIPTION OF SOME PREFERRED EMBODIMENTS OF THE PRESENT INVENTION

With reference to the flow chart illustrated in the accompanying drawing, the novel and unique method in accordance with the present invention begins with a company or entity, for example, Home Discount LLC, entering into a marketing agreement with a vendor of discounted products and/or services.

Upon obtaining marketing agreements with various such vendors of discounted products and/or services for the homeowner/customer, the company would market the discounted products and/or services via the Internet of the World Wide Web, direct mailing, or newspapers.

A potential customer, such as, for example, a homeowner, would then purchase discounted products and/or services via the Internet of the World Wide Web or telephone. The homeowner/customer may enter the system with a basic discount, or upon obtaining customer membership receive additional discounts as outlined in the lower right central portion of the flow chart.

The method in accordance with the present invention thus provides a one step shopping service for homeowners/customers via the Internet.

As indicated in the accompanying flow chart, the homeowner/customer can then proceed with obtaining service providers, product providers, enroll in customer membership to receive additional discounts, or advertise the business of the customer via the Internet, e-mail or U.S. mail.

As illustrated in the flow chart, if the homeowner/customer is seeking a service provider, the customer may select a service vendor based on the type of vendor desired, customer ratings of such vendor, and indicate the type of discount or coupons the homeowner/customer has available for such purpose.

Proceeding onward, the homeowner/customer may purchase various discounted services, such as, for example, the discounted services of a home improvement contractor, an interior/exterior designer, real estate and mortgages, cleaning services, home security, insurance, and other services required by residential homeowners.

Similarly, a homeowner/customer desiring to find a suitable product provider may select a suitable product vendor on the basis of the type of vendor desired by the homeowner/customer, customer ratings of such vendor and the type of discount or coupons available to the homeowner/customer.

Proceeding on, the homeowner/customer may then purchase the desired product, such as, for example, furniture products, appliance products, electronics and media products, flooring products, lighting products, and any other product which may be desired or needed by the residential homeowner.

The transaction is then finalized by the selected vendor delivering the product and/or service to the customer/homeowner.

As indicated hereinabove, the novel and unique method in accordance with the present invention provides a one stop shopping for the homeowner. In particular, the method in accordance with the present invention provides a centralized Internet-based web system that provides products and services for residential homeowners.

Although some preferred embodiments of the present invention have been described in detail hereinabove, all improvements, modifications, and other foreseeable variations are included in the scope of the present invention as set forth in the patent claims stated hereinbelow.

1. A method of providing one stop shopping for the home using a centralized Internet-based web system which enables a homeowner/customer to order products and/or services for residential homes, comprising the steps of:
obtaining a marketing agreement between a company and a vendor of discounted products and/or services;
marketing said discounted products and/or services by the Internet, direct mailing, and/or newspaper to homeowners/customers;
purchasing one or more of said discounted products and/or services via the Internet and/or telephone;
said discounted products includes, but is not limited to, furniture, appliances, electronics and media, flooring, lighting, etc.; and
said discounted services includes, but is not limited to, home improvement contractors, interior/exterior designers, real estate and mortgages, cleaning services, home security, insurance, etc.

2. The method according to claim 1, including the step of:
offering said homeowners/customers the ability via Internet and/or telephone to advertise the business of said homeowner/customer.

3. The method according to claim 1, including the step of:
offering to said homeowners/customers customer membership to receive additional discounts for said discounted products and/or services.

4. The method according to claim 2, including the step of:
offering to said homeowners/customers customer membership to receive additional discounts for said discounted products and/or services.

5. The method according to claim 1, wherein:
a homeowner/customer desiring to order discounted products is provided with the ability to select the type of vendor of said discounted product, a customer rating of said vendor of said discounted product, and the type of discount or coupons for said homeowner/customer.

6. The method according to claim 2, wherein:
a homeowner/customer desiring to order discounted products is provided with the ability to select the type of vendor of said discounted product, a customer rating of said vendor of said discounted product, and the type of discount or coupons for said homeowner/customer.

7. The method according to claim 3, wherein:
a homeowner/customer desiring to order discounted products is provided with the ability to select the type of vendor of said discounted product, a customer rating of said vendor of said discounted product, and the type of discount or coupons for said homeowner/customer.

8. The method according to claim 4, wherein:
a homeowner/customer desiring to order discounted products is provided with the ability to select the type of vendor of said discounted product, a customer rating of said vendor of said discounted product, and the type of discount or coupons for said homeowner/customer.

9. The method according to claim 1, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

10. The method according to claim 2, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

11. The method according to claim 3, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

12. The method according to claim 4, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

13. The method according to claim 5, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

14. The method according to claim 6, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

15. The method according to claim 7, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

16. The method according to claim 8, wherein:
a homeowner/customer desiring to order a discounted service from a service provider is provided with the ability to select the type of vendor of said desired discounted service, a customer rating of said vendor of said discounted service, and the type of discount or coupons to be used by said homeowner/customer.

17. The method according to claim 1, including the step of:
delivery of said purchased discounted product and/or service to said homeowner/customer by said vendor of said discounted product and/or service.

18. The method according to claim 2, including the step of:
delivery of said purchased discounted product and/or service to said homeowner/customer by said vendor of said discounted product and/or service.

19. The method according to claim 3, including the step of:
delivery of said purchased discounted product and/or service to said homeowner/customer by said vendor of said discounted product and/or service.

20. The method according to claim 4, including the step of:
delivery of said purchased discounted product and/or service to said homeowner/customer by said vendor of said discounted product and/or service.
